(19) United States
(12) Patent Application Publication
(10) Pub. No.: US 2022/0171785 A1
(43) Pub. Date: Jun. 2, 2022

(54) SYSTEMS AND METHODS OF AUTOMATING DATA PROCESSING AND MOVEMENT

(71) Applicant: T-MOBILE USA, INC., Bellevue, WA (US)

(72) Inventor: Giri babu Shivarathri, Bellevue, WA (US)

(21) Appl. No.: 17/109,036

(22) Filed: Dec. 1, 2020

(51) Int. Cl. G06F 16/25; G06F 16/22

(52) U.S. Cl. CPC G06F 16/254; G06F 16/258; G06F 16/2282

(57) ABSTRACT

The current disclosure relates to a system and method for automating data processing in ETL (extract, transform, load) or ELT data processing by automatically generating data processing scripts based on user inputs. In particular, the method includes receiving an input in a predefined format, where the input comprises at least one data processing instruction. Next, the method may include generating a temporary table script based on the input and implementing the temporary table script to obtain data from one or more data sources. Generating the temporary table script may include determining a plurality of temporary tables based upon the inputs and the data sources, which may include multiple stages of tables to facilitate efficient processing. One or more final temporary tables are then used to populate data into a target table.

### FIELD OF THE DISCLOSURE

The present disclosure generally relates to systems and methods for automatically generating one or more scripts to transform data, and more particularly, for generating scripts based on inputs in a predefined format to process data for one or more target tables.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Typically, in database management a database architect provides a specification for building and/or populating an object, such as a table. The specification details which databases to access to retrieve data for the object and how to organize the data within the object etc. A developer or other person tasked with development of data processing scripts then writes a script to process/transform data to populate the object based on the specification. This manual coding process requires time and testing, and it is generally cumbersome to modify if the specification changes.

### SUMMARY

As described further herein, the disclosure generally relates to systems, methods, and non-transitory computer-readable media storing instructions for automating data processing (including transformation and movement). These systems, methods, and instructions may comprise the following: receiving an input in a predefined format, wherein the input specifies a data source and a target table and comprises at least one data processing script and generating a temporary table script based on the input, wherein the temporary table script comprises instructions to generate a temporary table containing at least some of the data from the data source. Some embodiments may include implementing the temporary table script to generate the temporary table and populate the temporary table with temporary table data based on data from the data source and further implementing a target table script to populate the target table with the temporary table data.

Some embodiments may include generating the target table script based on the input and the temporary table script, wherein the target table script differs from the temporary table script. Generating the temporary table script may include determining a plurality of temporary tables based on the input, wherein the plurality of temporary tables includes the temporary table; and generating a separate temporary table script to generate and populate each of the plurality of temporary tables, wherein the temporary table is an image table matching a table structure of the target table; and one or more of the plurality of temporary tables are preliminary temporary tables configured to receive a subset of the data from the data source and to provide a subset of the temporary table data to the temporary table.

The input may be received in the form of a data table. In some such embodiments, one or more cells of the data table may include data along with processing scripts. Additionally or alternatively, the input may be received via a preconfigured user-interface. In some embodiments, the input may include an indication of a pattern indicating predefined parameters for temporary table script.

This summary is not comprehensive and is necessarily limited to certain aspects of the invention described herein. Additional or alternative components, aspects, functions, or actions may be included in various embodiments, as described further below.

### BRIEF DESCRIPTION OF THE DRAWINGS

FIG. 1 illustrates an example system for data management according to the techniques disclosed herein.

FIG. 2 illustrates an example method for generating scripts based on inputs in a predefined format.

FIG. 3 illustrates an example user-interface for receiving input data in a predefined format of an input table.

FIG. 4 illustrates an example user-interface for receiving input data from a user.

FIG. 5 illustrates example scripts that may be generated in response the received inputs.

FIG. 6 illustrates an example temporary table and an example target table that may be generated as described herein.

### DETAILED DESCRIPTION

The systems and methods of the current disclosure implements one or several techniques below for automatically generating scripts to process data for one or more target tables based on inputs in a predefined format. Rather than simply relying on a developer to manually create the script based on a specification, the system of the current disclosure automatically generates the scripts based on inputs. By automatically generating the scripts, the current disclosure offers a streamlined process that is less error-prone, easier to modify and test, and more efficient with both personnel and computing resources. Further, the system may automatically compile the scripts to process data through one or more intermediate/temporary tables and further populate one or more target tables.

In some instances, such as for large database management systems, one or more target tables may already exist and contain hundreds or thousands of rows/columns populated with a large data set. In order to update these target tables, it may be inefficient to add data directly to the table. For example, if data is incorrectly added to the target table it may be difficult to correct the error due to the size of the target table. Instead of adding data directly to the target table, it is best practice to first add the data to one or more temporary tables replicating at least the relevant part of the format of the target table or target tables. Thus, the current system generates scripts to create one or more temporary tables to process data. The one or more temporary tables may be merged with the target table in order to populate the target table. The implementation of temporary tables is more efficient for processing data and may prevent performance issues and large scale errors in the target table.

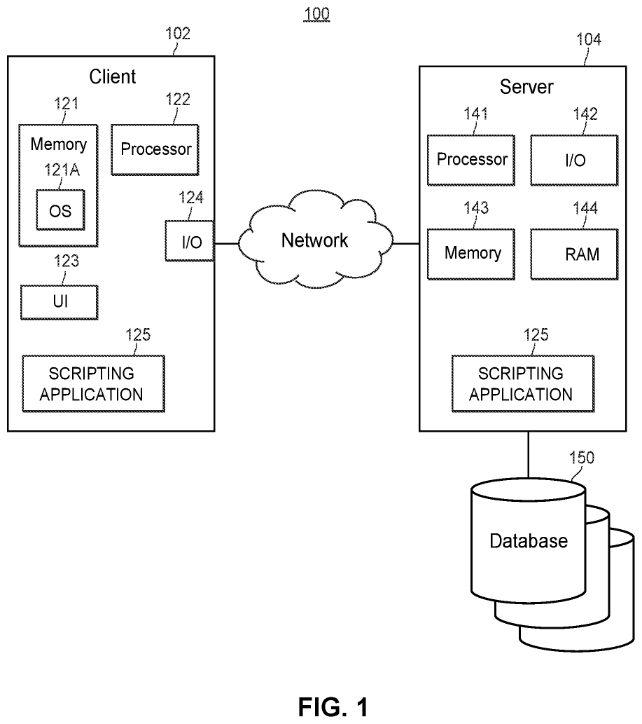

An example computing environment in which the system of this disclosure can operate is discussed first with reference to FIG. 1, followed by a discussion of several example use cases and methods that can be implemented in the system. FIG. 1 illustrates a block diagram of an example system 100 in accordance with an exemplary embodiment of the present disclosure. The system 100 may implement the techniques outlined above and described in further detail below. The system 100 may include a client computing device 102, a server 104, and a network 106. Although FIG. 1 only illustrates a single example of each device for simplicity, it should be understood that any suitable number of devices 102 and 104 may be included in the system 100.

FIG. 1 includes a client computing device 102 which may be, for example, a computer, a laptop, a smart device, a tablet, or any other suitable computing device. The computing environment 100 in general can include any suitable number of client computing devices 102 operating and communicatively coupled to the network 106. The client computing device 102 can include a memory 121, one or more processors 122, a network interface 124, a user interface (UI) 123, as well as a scripting application 125 for managing data in the system as described further below.

The memory 121 may be a non-transitory memory and may include an operating system 121A and one or several suitable memory modules, such as random-access memory (RAM), read-only memory (ROM), flash memory, other types of persistent memory, etc. The network interface 124 can support any suitable communication protocol to communicate with remote servers and other devices via the communication network 106. The UI 123 can include any suitable combination of input devices such as a touchscreen, a keyboard, a microphone, etc. and output devices such as screens, speakers, etc. The memory 121 stores an operating system (OS) 121A, which can be any type of suitable mobile or general-purpose operating system.

The system 100 further includes one or more servers 104 communicatively coupled to the client computing device 102 via network 106. The server 104 can receive data from the client computing device 102 and other client devices, and further retrieve data from databases 150. The computing environment 100 in general can include any suitable number of providers of content and/or databases as necessary to store and compile data. The server 104 and the client computing device 102 can communicate via a network 106, which can be a wide area network such as the internet, for example, and include wired and/or wireless communication links.

For simplicity, FIG. 1 illustrates the server 104 as only one instance of a server device. However, the server 104 according to some implementations includes a group of one or more server devices, each equipped with one or more processors and capable of operating independently of the other server devices. Server devices operating in such a group can process requests from the client computing device 102 individually (e.g., based on availability), in a distributed manner where one operation associated with processing a request is performed on one server device while another operation associated with processing the same request is performed on another server device, or according to any other suitable technique. For the purposes of this discussion, the term “server” may refer to an individual server device or to a group of two or more server devices.

With continued reference to FIG. 1, the server 104 includes one or more processors 141 a network interface 142 and a non-transitory memory 143 (e.g., a hard disk, a flash drive). The memory 143 may be a non-transitory memory and may include one or several suitable memory modules, such as random-access memory (RAM 144), read-only memory (ROM), flash memory, other types of persistent memory, etc. The network interface 142 may support any suitable communication protocol to communicate with remote servers and other devices via the communication network 106. In an embodiment, the memory 143 may store instructions that implement a database management system using scripting application 125. The instructions that implement the scripting application 125 are executable on the one or more processors 141.

Scripting application 125 may implement various techniques to receive and analyze inputs in order to generate one or more scripts. In some embodiments, scripting application 125 may further be configured to generate scripts to create one or more temporary tables and subsequently populate the temporary tables with data from databases 150 or any other device which can provide data (e.g., static data repositories or data streams). Further, the scripting application 125 may be configured to generate scripts to generate and/or populate one or more target tables based on the temporary tables. For example, the scripts may include a merge function that merges one or more temporary tables into one or more target tables. In an embodiment, the scripting application 125 may be configured to generate scripts that are optimized based on a target table platform.

The scripting application 125 may receive inputs from a device, such as client computing device 102, or may retrieve inputs from one or more databases, such as databases 150. In some embodiments, scripting application 125 may receive inputs in the form of one or more files having a predefined structure, such as a spreadsheet document. In other embodiments, scripting application 125 may be configured to receive inputs through data entry fields presented via the user-interface of a device, such as UI 123 of client computing device 102. For example, scripting application 125 may be configured to display one or more prompts or queries in order to receive inputs via one or more application pages or web pages.

In various embodiments, scripting application 125 may be deployed in whole by the server 104 or the client computing device 102. In other embodiments, the scripting application 125 may be deployed across multiple devices, such as the client computing device 102 and the server 104, to receive inputs and generate scripts. The process implemented by scripting application 125 is discussed in greater detail below.

The server 104 can be communicatively coupled to one or more databases 150 that store data that scripting application 125 can use generate scripts to process data and/or populate one or more output tables. The databases 150 may store private and/or publicly accessible data, or any combination of the two. For example, the databases 150 may include one or more databases for a specific organization including data related to customers, sales, employees, inventory, etc. In some embodiments, one or more databases 150 may be protected by a firewall and/or other security measures. In these embodiments, the server 104 may be specially configured to access the data in the protected databases 150. In general, the server 104 can access any suitable number of databases not pictured in FIG. 1.

With continued reference to FIG. 1, network 106 may be configured as any suitable network configured to facilitate communications between one or more computing devices 102, and server 104. For example, network 106 may be coupled to one or more devices via one or more landline, Internet Service Provider (ISP) backbone connections, satellite links, public switched telephone networks (PSTNs), etc.

To provide additional examples, network 106 may include a proprietary network, a secure public internet, a mobile-based network, a virtual private network, etc. Network 106 may include any suitable number of interconnected network components that form an aggregate network system, such as dedicated access lines, plain ordinary telephone lines, satellite links, cellular base stations, a public switched telephone network (PSTN), etc., or any suitable combination thereof.

In some embodiments, network 106 may facilitate one or more computing devices 102 connecting to the Internet. In embodiments in which network 106 facilitates a connection to the Internet, data communications may take place over communication network 106 via one or more suitable Internet communication protocols. In various embodiments, network 106 may be implemented, for example, as a wireless telephony network (e.g., GSM, CDMA, LTE, etc.), a Wi-Fi network (e.g., via one or more IEEE 802.11 Standards), a WiMAX network, etc.

Server 104 may include one or more external computing devices, which may be implemented as any suitable number of components configured to store, receive, and or transmit data from one or more client computing devices 102 and/or databases 150 via communication network 106 or any other suitable combination of wired and/or wireless links. In various embodiments, the server 104 may be configured to execute one or more applications to facilitate one or more aspects of the functionality used in accordance with one or more embodiments as discussed herein.

In various embodiments, the client computing device 102, the server, 104 and/or databases 150 may store and/or access secure data that is of a private, proprietary, and/or sensitive nature. As a result, various embodiments of server 104, network 106, and/or one or more computing devices 102 may implement appropriate security protocols such as encryption, secure links, network authentication, firewalls, etc., to appropriately protect and secure such data.

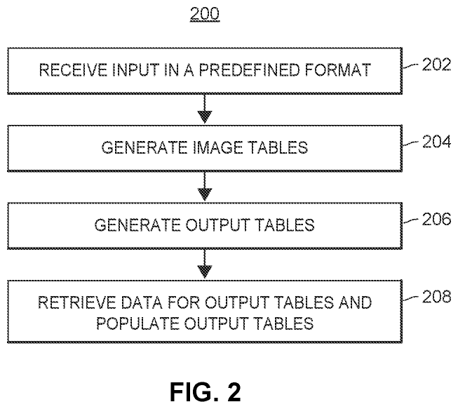

FIG. 2 illustrates a flow diagram of an exemplary method 200 for generating scripts for processing data and populating target tables based on inputs in a predefined format. The method may be implemented, as described above, by communicatively coupled components of the system 100 as illustrated in FIG. 1. However, in some embodiments, the method 200 may be performed in whole by the server 104. In other embodiments, the method 200 may be performed in any suitable combination of components of the system 100.

The method may begin by receiving (block 202) an input in a predefined format. The system may receive the input through a user interface of an input device, such as client computing device 102 of FIG. 1. Typically, an input will provide requirements of the target table or transformation logic. For example, an input may include the data definition language (DDL), ETL (extract, transform, load) or ELT specifications, load strategies, data processing methodology (type 2, type 3, etc.), encryption requirements, and information on database sourcing. Further, the input may provide specific details regarding the target tables including column names, number of columns, number of rows, estimated file size, etc. The input may additionally include transformation logic per target column. The transformation logic may indicate how to process the data for each column or data source, including manipulations to be performed on the value and join conditions for preparing data for loading into the one or more target tables.

In some embodiments, the input may also include one or more scripts or script portions which indicate transformation rules per column, along with any data processing requirements such as late arriving dimensions, surrogate key generation, etc. The scripts or script portions in the inputs may be in any suitable programming language. In some embodiments, however, the scripting application 125 may require the scripts or script portions in the inputs to be written in a language directly executable by the target database (e.g., SQL script portions for SQL databases).

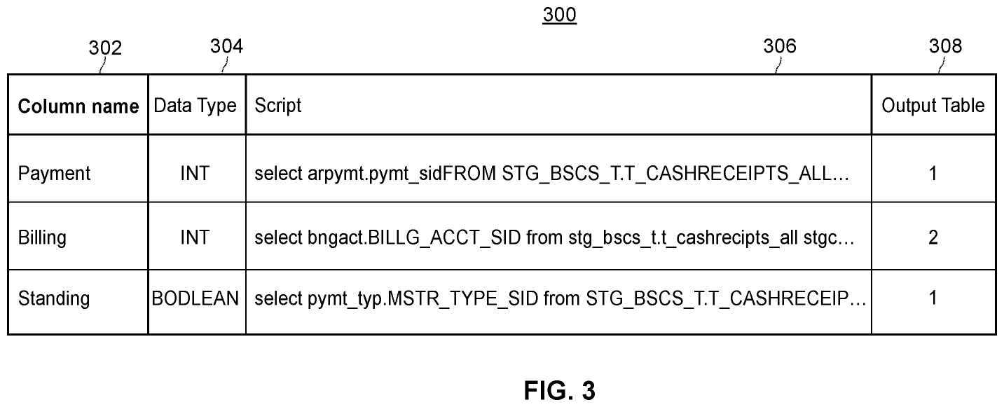

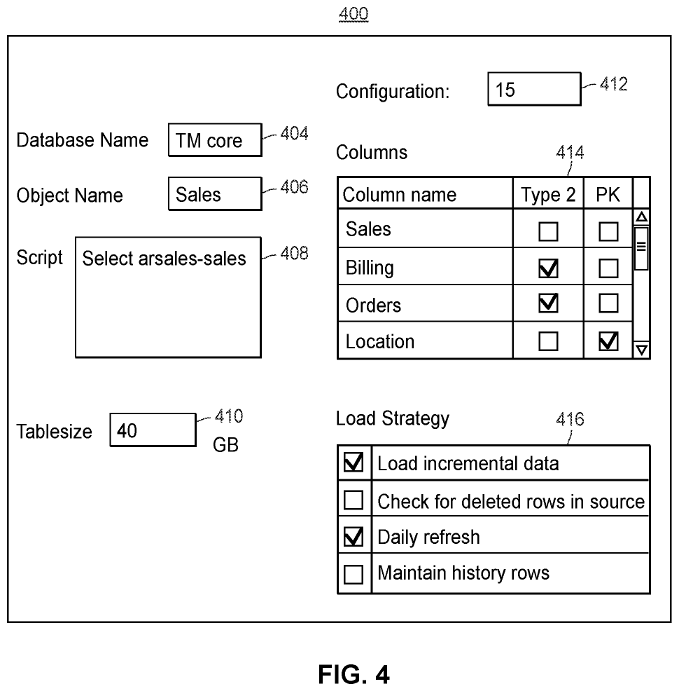

The inputs of the system may be in a predefined format. By adhering to a specific format requirement, the system may be able to process the inputs and generate scripts and/or temporary tables without the need for manual intervention. Example inputs are described in greater detail below with respect to FIGS. 3 and 4.

Next, the system may generate scripts based upon the inputs to generate and populate one or more temporary tables (block 204). Each such temporary table is a table built in order to process the data intended to be entered in the final target table. In an embodiment, a temporary table may include a number of columns and rows intended for the final target table, which may be a subset of the data to be entered in the final target table. In this embodiment, the system may process data and enter the data into the temporary table. If no errors occur in populating the temporary table, then the temporary table may be merged into a target table such that the target table is populated with the processed data.

In some embodiments, a plurality of stages of temporary tables may be used to process the data. Thus, in some embodiments, the scripts may be generated to cause the creation and population of one or more preliminary temporary tables in order to prepare a portion of the source data for addition to a secondary temporary table. Such secondary temporary table may be an image table having the same structure and format as a corresponding target table. In such embodiments, the use of preliminary and secondary temporary tables (and the generation of corresponding scripts) is determined automatically based upon the inputs in order to efficiently manage complex data processing (e.g., joining of partially redundant data with deduplication of the data, reformatting of the data, or validation of the data before adding the data to an image table).

To generate the one or more temporary tables, the system may first identify the number of temporary tables to create in order to process the data efficiently. For example, the system may analyze the input to determine the number of temporary tables to create. The number of temporary tables may be based on size restrictions in the inputs, the number of target tables, the structure of the source data, etc. For each temporary table, the system may determine the number of columns, including the number of driver columns (i.e., target primary key (PK) columns) and rows to include. The system may then extract objects related to the columns, such as the column name and/or size. Configuration of the data sets and various inputs can be taken into consideration while generating the data processing scripts in order to ensure that the generated scripts process data optimally.

In some embodiments, the system may generate a temporary table script that may be run by the system (either automatically or upon a user request by a user) to generate and populate the one or more temporary tables. The temporary table script may be in any suitable programming language. In some embodiments, the temporary table script may be edited by a user prior to being implemented. In other embodiments, the system may automatically implement the script to generate one or more temporary tables. The temporary table script may reflect some or all of the information included in the received inputs. For example, the temporary table script may not include instructions for retrieving data for populating the table as indicated in the inputs. In some embodiments, the temporary table script may include the one or more scripts from the input. In other embodiments, the temporary table script may include portions of the one or more scripts from the input.

The system may then implement the generated scripts to process the data through the temporary tables (block 206). In an embodiment, processing the data may include retrieving the data from one or more databases and populating one or more temporary tables with the retrieved data, which may occur through a single stage or in multiple stages of temporary tables. By processing the data through the temporary tables, the system allows for troubleshooting/testing of the computationally expensive tasks of retrieving/processing the data prior to populating the target table. Additionally, data validation can be performed and modifications can be applied to a temporary table prior to determining how the changes impact the target table. If the results are acceptable, then the modifications can be applied to populating the one or more target tables. Thus, in some embodiments, the resulting one or more final temporary tables may be validated prior to proceeding. Such validation may be performed automatically by implementing further scripts or may be performed manually by requiring a user to authorize adding the final temporary table data to the corresponding one or more target tables.

Once the scripts have been implemented to populate one or more final temporary tables with the appropriate data, the one or more target tables are populated with the data from the final temporary tables (block 208). In some embodiments, this may include loading the data from the final temporary tables into target tables to add or update the data in such existing tables through a merge operation, for example. When a final temporary table is an image of an existing target table, such final temporary table may simply be merged into the existing target table. If a target table has not yet been generated, a script (previously generated at block 204 above) may be run to generate the target table and populate data from one or more final temporary tables.

The process for populating the target table may be similar to the process for generating the one or more temporary tables. For example, the system may generate and run a target table script based on the input and/or the temporary table script. However, the target table script may differ from the temporary table script by having more, fewer, or different commands/lines of code.

As described above, the inputs used by the scripting application 125 may be in a predefined format. In one embodiment, the predefined format may be an input table with a preset number of columns and/or rows configured to receive predefined types of inputs (e.g., table identifiers, column identifiers, conditions, or scripts). FIG. 3 illustrates an example input for the scripting application 125 in a predefined format of an input table 300. The system may analyze the input 300 to generate one or more temporary table scripts and/or target table scripts, as described above.

In some embodiments, the data table 300 may include information indicative of how the temporary tables are to be constructed. For example, the input may indicate the column names 302 for the temporary tables. In some embodiments, the input may also indicate the data type 304 or data format for data in the temporary tables. For example, the input may indicate that the data should be in the form of an integer, a Boolean data type, a string, etc.

In some embodiments, the input may include a script 306 detailing how the temporary table is to be constructed. The script 306 may include commands indicating which database to access for data to populate the temporary table and/or a specific query for data. In other embodiments, the script may include instructions for how to process data. In still other embodiments, the script may include clauses such as joins, where, qualify, etc. indicating how the data will be organized in the output table.

In some embodiments, the input may include predefined functions for generating the scripts, known as patterns. Patterns can also be used to specify advanced transformation logic. Such patterns may include frequently-used sets of parameters or transformation logic that may be used to save time. Here, the input may indicate which specific pattern 308 to implement when generating scripts. The example input table 300 of FIG. 3 is intended for illustrative purposes and is not intended to be limiting. Input tables 300 may include further information for generating scripts for temporary tables and target tables, as described above. Further, input tables 300 may also include any of the information described below in the example user-interface 400 of FIG. 4 below. In some embodiments, the script generation process can automatically selectively override user given specifications based on a more suitable approach for processing data. For example, the system may group or combine the processing of multiple columns together, even if the user input indicated processing the columns separately.

In some embodiments, the system may receive the input through a user-interface 400, as illustrated in FIG. 4. The user-interface 400 may be configured to receive inputs related to generating scripts. For example, the user-interface 400 may be configured to receive inputs for a database 404 and an object name 406. The database 404 may indicate a specific database for retrieving data to populate the target table. In some embodiments, the database 404 may be one or more of a file (unstructured, semi-structured, or structured), one or more objects in an external database, one or more objects in an internal database, etc. In an embodiment, the process of generating scripts and populating the target table may also include generating code/scripts to extract data from a source (e.g., files or objects) to populate temporary tables and/or target tables. The data may be in acceptable format (such an existing data table) and may be retrieved from any accessible database in the system. The object name 406 may indicate the target table which is being generated and/or populated.

In an embodiment, the user-interface 400 may be configured to receive one or more scripts 408. As described above, the scripts may include any suitable instructions to indicate how the temporary tables should be constructed or how the data for such tables is to be processed. The user-interface may also be configured to receive a table size 410. In an embodiment, the table size 410 may be used as a threshold for the system. If the system determines, when generating temporary tables, that the tables will exceed the table size 410, the system may then generate additional temporary tables to divide the data into smaller subsets for improved processing.

The user-interface 400 may also be configured to receive a configuration 412. The configuration 412 may indicate how the final temporary tables are to be organized. In an embodiment, the system may include a number of selectable configurations 412.

Further, the user-interface 400 may be configured to receive a selection of one or more columns 414 to include in the temporary tables. As illustrated in example user-interface 400, the columns 414 may be distinguished by type (e.g., type 2, PK) which will be used by the system when generating temporary tables.

Further, the user-interface 400 may be configured to receive one or more load strategies 416. The load strategies 416 further define how the data is to be processed for the temporary tables. For example, the load strategy 416 may receive an indication for how often the system should retrieve new data for the temporary tables. For example, the process of generating temporary tables and processing source data for updating a target table may be performed on a periodic basis for batches of source data (e.g., for daily, weekly, or monthly updates).

The example user-interface 400 is not intended to be limiting and only serves as an illustrative example of an input for the system. In an embodiment, the user-interface 400 may include multiple tabs to receive various inputs used to generate output tables. The user-interface may be configured to receive any information necessary to generate scripts for temporary tables and target tables. For example, the user-interface 400 may be configured to receive any information typically included in a specification previously used to define object parameters.

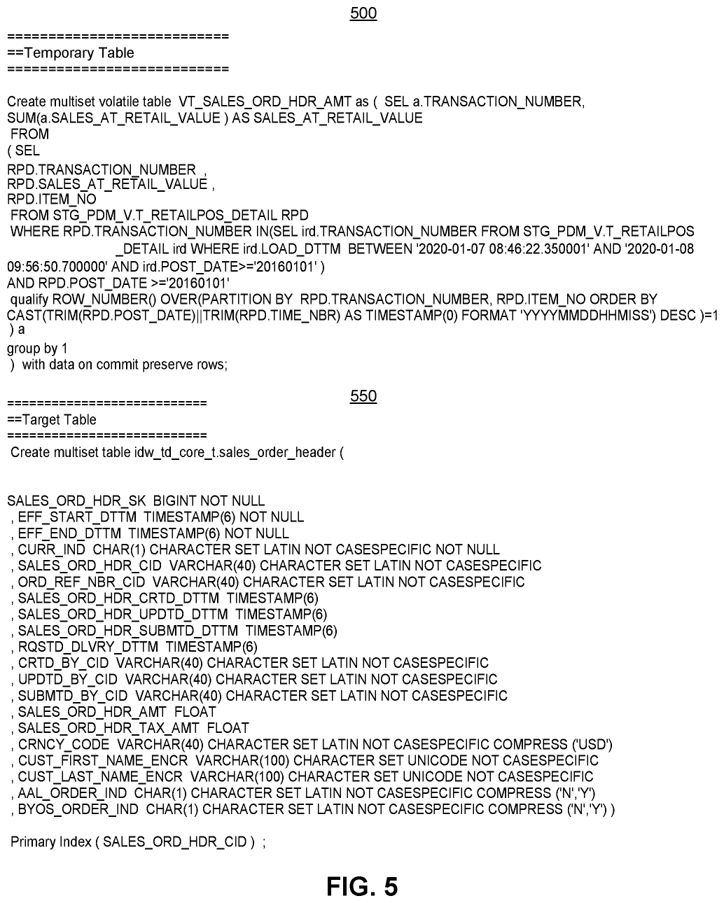

FIG. 5 illustrates example scripts 500 and 550 that may be generated by the system of the current disclosure in response the received inputs. In an embodiment, the scripts may be optimized based on the target table platform. For example, the system may identify a target table and determine a number of calls/operations/functions/etc. that may be implemented in the script to minimize use of resources and processing power during compilation based on the target table platform. Temporary table script 500 illustrates an example script for generating and populating a temporary table based on an input (such as the example input from user-interface 400 of FIG. 4). In an embodiment, the temporary table script 500 may be displayed on a user-interface in an editable format, such that a user may edit the script prior to compilation. In another embodiment, the temporary table script 500 may be automatically run by the system.

Further target table script 550 illustrates an example target table script based on an input (such as the example input from user-interface 400 of FIG. 4) as well as the temporary table script 500. In an embodiment, the target table script 550 may completely incorporate the temporary table script 500. For example, if the system generates multiple temporary tables, the system may then generate a target table script corresponding to each temporary table. Thus, the target table script 550 would need to reflect the temporary table script 500 such that there is an appropriate number of target table scripts and such that each target table script corresponds to a temporary table.

In an embodiment, the target table script 550 may be displayed on a user-interface in an editable format, such that a user may edit the script prior to compilation. In another embodiment, the output table script 550 may be automatically compiled by the system.

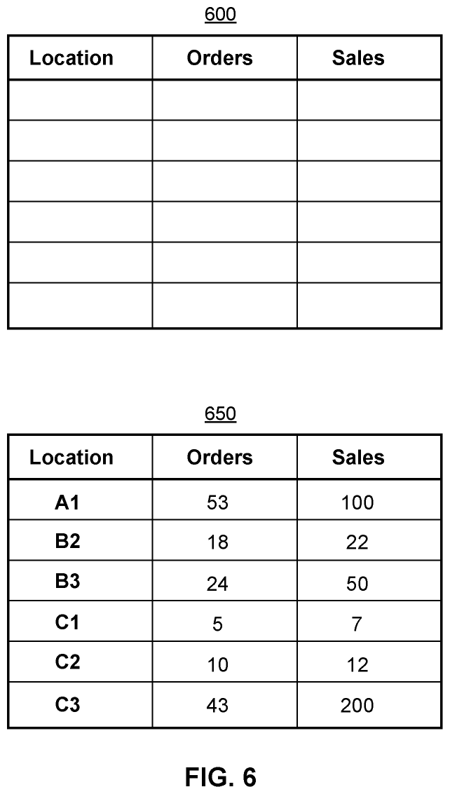

FIG. 6 illustrates an example temporary table 600 and an example target table 650. As described above, the target table 650 reflects the temporary table 600. However, the target table is populated with data retrieved from one or more databases, as indicated in the input. As described above, the temporary table may be generated first, and any errors in the temporary table may be corrected. Although not illustrated in FIG. 6, the temporary table may be populated with data after being generated or at the same time as it is generated. Then, in an embodiment, the temporary table data may be merged into the target table such that the target table is populated with the newly retrieved data.

Although individual operations of one or more methods are illustrated and described as separate operations, one or more of the individual operations may be performed concurrently, and nothing requires that the operations be performed in the order illustrated. Structures and components presented as separate components in example configurations may be implemented as a combined structure or component. Similarly, structures and components presented as a single component may be implemented as separate components. These and other variations, modifications, additions, and improvements fall within the scope of the subject matter herein.

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for systems and methods according to the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the techniques disclosed herein without departing from the spirit and scope defined in the appended claims.

The embodiments described above may be implemented in hardware, software, or a combination thereof to transmit or receive described data or conduct described exchanges. In the context of software, the illustrated blocks and exchanges represent computer-executable instructions that, when executed by one or more processors, cause the processors to transmit or receive the recited data. Generally, computer-executable instructions, e.g., stored in program modules that define operating logic, include routines, programs, objects, modules, components, data structures, and the like that perform particular functions or implement particular abstract data types. Except as expressly, impliedly, or inherently set forth herein, the order in which the transmissions or operations are described is not intended to be construed as a limitation, and any number of the described transmissions or operations can be combined in any order and/or in parallel to implement the processes. Moreover, structures or operations described with respect to a single server or device can be performed by each of multiple devices, independently or in a coordinated manner, except as expressly set forth herein.

Other architectures can be used to implement the described functionality, and are intended to be within the scope of this disclosure. Further, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

The word “or” is used herein in an inclusive sense unless specifically stated otherwise. Accordingly, conjunctive language such as the phrases “X, Y, or Z” or “at least one of X, Y or Z,” unless specifically stated otherwise, is to be understood as signifying that an item, term, etc., can be any of X, Y, or Z, or any combination thereof.

Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims. Moreover, in the claims, any reference to a group of items provided by a preceding claim clause is a reference to at least some of the items in the group of items, unless specifically stated otherwise.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, the patent claims at the end of this patent application are not intended to be construed under 35 U.S.C. § 112(f), unless traditional means-plus-function language is expressly recited, such as “means for” or “step for” language being explicitly recited in the claims.

1. A computer-implemented method for automating data processing, the method comprising:
receiving, by one or more processors, an input in a predefined format, wherein the input specifies a data source, a temporary table format, a temporary table size limit, a target table, and at least one data processing script portion;
generating, by the one or more processors, a temporary table script based on the input, wherein the temporary table script comprises instructions to generate a temporary table containing at least some of the data from the data source, and formatted based upon the temporary table format;
determining, by the one or more processors, a size of the temporary table based upon the temporary table script;
when the size of the temporary table would satisfy the temporary table size limit:
implementing, by the one or more processors, the temporary table script to generate the temporary table and populate the temporary table with temporary table data based on data from the data source, and
implementing, by the one or more processors, a target table script to populate the target table with the temporary table data from the temporary table; and
when the size of the temporary table would not satisfy the temporary table size limit:
splitting, by the one or more processors, the temporary table into a plurality of temporary tables that each satisfy the temporary table size limit, and are formatted based upon the temporary table format,
generating, by the one or more processors, a plurality of different temporary table scripts for respective ones of the plurality of temporary tables, wherein each of the plurality of temporary table scripts comprises instructions to generate the respective temporary table of the plurality of temporary tables,
implementing, by the one or more processors, the plurality of temporary table scripts to generate the plurality of temporary tables and populate the plurality of temporary tables with respective temporary table data based on data from the data source, and
implementing, by the one or more processors, one or more target table scripts to populate the target table with the temporary table data from the plurality of temporary tables.

2. The computer-implemented method of claim 1, further comprising:
generating, by the one or more processors, the target table script based on the input and the temporary table script, wherein the target table script differs from the temporary table script.

3. (canceled)

4. The computer-implemented method of claim 1, wherein:
the temporary table is an image table matching a table structure of the target table; and
the one or more of the plurality of temporary tables are preliminary temporary tables configured to receive a subset of the data from the data source and to provide a subset of the temporary table data to the temporary table.

5. The computer-implemented method of claim 1, wherein the input is received in the form of a data table.

6. The computer-implemented method of claim 5, wherein at least one cell of the data table includes the at least one data processing script portion.

7. The computer-implemented method of claim 1, wherein the temporary table script is optimized based on a target table format of the target table.

8. The computer-implemented method of claim 1, wherein the input includes an indication of a pattern indicating predefined parameters for the temporary table script.

9. A system for automating data processing, the system comprising:
one or more non-transitory storage media configured to store processor executable instructions; and
one or more processors operatively connected to the one or more non-transitory storage media and configured to execute the processor executable instructions to cause the system to:
receive an input in a predefined format, wherein the input specifies a data source, a temporary table format, a temporary table size limit, a target table, and at least one data processing script portion;
generate a temporary table script based on the input, wherein the temporary table script comprises instructions to generate a temporary table containing at least some of the data from the data source, and formatted based upon the temporary table format;
determine a size of the temporary table based upon the temporary table script;
when the size of the temporary table would satisfy the temporary table size limit:
implement the temporary table script to generate the temporary table and populate the temporary table with temporary table data based on data from the data source, and
implement a target table script to populate the target table with the temporary table data from the temporary table; and
when the size of the temporary table would not satisfy the temporary table size limit:
split the temporary table into a plurality of temporary tables that each satisfy the temporary table size limit, and are formatted based upon the temporary table format,
generate a plurality of different temporary table scripts for respective ones of the plurality of temporary tables, wherein each of the plurality of temporary table scripts comprises instructions to generate the respective temporary table of the plurality of temporary tables,
implement the plurality of temporary table scripts to generate the plurality of temporary tables and populate the plurality of temporary tables with respective temporary table data based on data from the data source, and
implement one or more target table scripts to populate the target table with the temporary table data from the plurality of temporary tables.

10. The system of claim 9, wherein the instructions further cause the system to:
generate the target table script based on the input and the temporary table script, wherein the target table script differs from the temporary table script.

11. (canceled)

12. The system of claim 9, wherein:
the temporary table is an image table matching a table structure of the target table; and
the one or more of the plurality of temporary tables are preliminary temporary tables configured to receive a subset of the data from the data source and to provide a subset of the temporary table data to the temporary table.

13. The system of claim 9, wherein the input is received in the form of a data table.

14. The computer-implemented method of claim 13, wherein at least one cell of the data table includes the at least one data processing script portion.

15. A tangible non-transitory computer-readable medium storing processor executable instructions that, when executed by one or more processors of a system, cause the system to:
receive an input in a predefined format, wherein the input specifies a data source, a temporary table format, a temporary table size limit, a target table, and at least one data processing script;
generate a temporary table script based on the input, wherein the temporary table script comprises instructions to generate a temporary table containing at least some of the data from the data source, and formatted based upon the temporary table format;
determine a size of the temporary table based upon the temporary table script;
when the size of the temporary table would satisfy the temporary table size limit:
implement the temporary table script to generate the temporary table and populate the temporary table with temporary table data based on data from the data source, and
implement a target table script to populate the target table with the temporary table data from the temporary table; and
when the size of the temporary table would not satisfy the temporary table size limit:
split the temporary table into a plurality of temporary tables that each satisfy the temporary table size limit, and are formatted based upon the temporary table format,
generate a plurality of different temporary table scripts for respective ones of the plurality of temporary tables, wherein each of the plurality of temporary table scripts comprises instructions to generate the respective temporary table of the plurality of temporary tables,
implement the plurality of temporary table scripts to generate the plurality of temporary tables and populate the plurality of temporary tables with respective temporary table data based on data from the data source, and
implement one or more target table scripts to populate the target table with the temporary table data from the plurality of temporary tables.

16. The tangible non-transitory computer-readable medium of claim 15, wherein the instructions further cause the system to:
generate the target table script based on the input and the temporary table script, wherein the target table script differs from the temporary table script.

17. (canceled)

18. The tangible non-transitory computer-readable medium of claim 15, wherein:
the temporary table is an image table matching a table structure of the target table; and
the one or more of the plurality of temporary tables are preliminary temporary tables configured to receive a subset of the data from the data source and to provide a subset of the temporary table data to the temporary table.

19. The tangible non-transitory computer-readable medium of claim 15, wherein the input is received in the form of a data table.

20. The tangible non-transitory computer-readable medium of claim 19, wherein at least one cell of the data table includes the at least one data processing script portion.
